(19) United States
(12) Patent Application Publication
(10) Pub. No.: US 2026/0085779 A1
(43) Pub. Date: Mar. 26, 2026

(54) POWER SYSTEM OF WATER HAMMER EFFECT

(71) Applicant: Pik Heung HO, Hong Kong (CN)

(72) Inventors: Pik Heung HO, Hong Kong (CN); Chi Keung LIU, Hong Kong (CN)

(21) Appl. No.: 19/296,511

(22) Filed: Aug. 11, 2025

Related U.S. Application Data
(63) Continuation of application No. PCT/CN2025/107926, filed on Jul. 10, 2025.

(30) Foreign Application Priority Data
Sep. 26, 2024 (CN) 202411349900.7

(51) Int. Cl. F16L 55/05; H02K 7/18

(52) U.S. Cl. CPC F16L 55/05; H02K 7/1876

(57) ABSTRACT

A power system of water hammer effect includes a pressure cylinder connected to a pressure water pipe. A pressure branch pipe is disposed on the pressure water pipe, and a trigger valve is mounted on the pressure branch pipe. The pressure cylinder defines a hollow chamber, a piston is slidably mounted inside the hollow chamber, and a piston rod is mounted on an end of the piston, penetrates to an outside of the pressure cylinder and slidably connected to the pressure cylinder. The hollow chamber defines a drainage cavity therein, which includes a loosened ring and a drainage collection ring, and the drainage collection ring defines a drainage port thereon. The loosened ring and the drainage collection ring on cylinder body inner wall drain and release pressurized water inside the system, so that the piston quickly returns to its position without impact or compression, and enters a next stamping stroke.

### CROSS-REFERENCE TO RELATED APPLICATION

This application claims priority to Chinese Patent Application No. 202411349900.7, filed on September 26, 2024, which is herein incorporated by reference in its entirety.

### TECHNICAL FIELD

The disclosure relates to the field of water hammer power technologies, and more particularly to a power system of water hammer effect.

### BACKGROUND

Approximately 70% of Earth’s surface is covered by water, making water resources extremely abundant. However, hydropower accounts for less than 17% of global electricity generation. Traditional hydropower generation relies on high water levels and large water flows, which makes construction of dams an inevitable choice. However, there are only a limited number of suitable sites for dam construction. Building a dam requires a significant investment of human, material, and financial resources, as well as a lengthy construction period, and it causes irreversible and substantial environmental impacts. Due to an extremely high construction cost and difficulty of traditional hydropower, only national level projects or large consortiums can usually afford it. The aforementioned factors intertwined with each other, forming an insurmountable bottleneck that seriously restricts a further development of the hydropower.

The disclosure provides a power system of water hammer effect to open up a broad prospect for further development of natural water energy, which is a solution that was inspired by a water hammer phenomenon caused by a faulty faucet.

Over a decade ago, the inventor encountered a phenomenon in his kitchen at home. When a faulty faucet was abruptly closed, it began to drip slightly and produced intense vibrations. These vibrations propagated through pipes installed on exterior walls, affecting an entire building, particularly during the night and early morning when they were especially noticeable and disruptive. After repeated observations and analyses, the inventor discovered that these vibrations and leaks only occurred when water supply was suddenly closed, and they did not occur when the water was closed gradually. Clearly, this was a classic case of the water hammer phenomenon, a faucet component weighing 38 gram (g) was being impacted by the water hammer.

The water hammer phenomenon occurs when a flow of water in a pipe is suddenly blocked at a front end, while the water behind continues to push forward, generating an impact force that can be tens to hundreds of times greater than a normal water pressure. The water hammer phenomenon is often observed in faulty faucets, which demonstrates an alternative way to harness natural water energy.

The inventor conducted repeated observations and multiple tests on the faulty faucet phenomenon and found its performance to be remarkably stable. In three tests, the amount of water drainage after one hundred vibrations was collected each time, measuring 150 g, 150 g, and 130 g respectively, with an average water drainage per vibration of 1.5 g. Such a minuscule amount of water drainage (only 1.5 g) was enough to cause a commotion throughout the entire building, fully demonstrating the immense power of the energy generated by the water hammer effect.

Based on these observations, when the amount of water drainage of just one kilogram (kg) is used, a vibration effect more than six hundred times greater is achieved. Thus, what would happen when this effect is magnified ten thousand times? However, the amount of water drainage ten thousand times greater would only amount to 15 kg. Moreover, how much effect can 15 kg of water be used to drive a hydraulic turbine? From this perspective, it is evident that the potential for developing water hammer power is enormous.

Many people are filled with anticipation for the immense potential energy contained within the water hammer phenomenon, and a review of patent literature reveals some relevant records. However, up to now, no one has been able to successfully demonstrate how to enable the water hammer effect to meet fundamental conditions required to serve as a source of power. When the energy harnessed from the water hammer effect is negligible, then further developing it into a viable power source becomes meaningless.

In order to transform the energy generated by the water hammer effect into usable power, it is imperative to address a critical issue of achieving continuous and effective impacts. This involves two core elements: continuity and effectiveness. Continuity is the foundation, without uninterrupted impacts, a stable power source cannot be established. Effectiveness is the key, only through effective impacts can the true value of this energy as a power source be realized. Theoretically, the water hammer effect can generate energy up to two hundred times the original water pressure. When current technology can enable the water hammer effect to produce energy thirty to forty times the original water pressure, with an obtaining rate of 70% to 80%, then developing it as a power source holds significant value. This is the true essence of effective impacts. With ongoing technological advancements, both the energy generated by the water hammer effect and the energy obtaining rate are expected to continually improve.

The water hammer phenomenon is caused by the faulty faucet, which drains only 1.5 g of water per vibration, and is sufficient to create a commotion throughout the entire building. Such a minuscule amount of water drainage can impact the faucet component weighing 38 g. How is this highly efficient vibration effect achieved? After extensive observation and deep contemplation, the inventor has understood a solution of a “leakage drainage technology”. This technological solution successfully addresses the challenge of achieving continuous and effective impacts, offering an efficient, simple, and cost-effective method for the further development of natural hydropower. In the future, hydropower generation is expected to become a project that ordinary enterprises can easily undertake.

In nature, there are many locations with significant water level differences but unsuitable for dam construction, as well as locations with high water levels but insufficient flow rates. These locations are ideal for an application of water hammer power devices. Instead of building dams, simply laying pressure pipelines can serve as a main infrastructure. This approach not only saves a substantial amount of human, material, and financial resources, as well as construction time, but also has a negligible impact on the environment. Currently, pumped-storage hydropower generation is gaining popularity as an emerging technology. When the water hammer power devices are utilized in this field, efficiency could be increased by tens of times. Based on a principle of the pumped-storage hydropower generation, in places where water is available, simply digging a pit can enable power generation through the water hammer effect. Furthermore, as long as there is a certain amount of water in any place, the continuous flow of water can provide a continuous source of power, that is, if there are ten tons of water here, by pumping it to an elevated position to convert it into potential energy and generating power through the water hammer effect, the same water can be repeatedly pumped back up after use, ensuring a perpetual cycle of reuse, an inexhaustible water supply, and a continuous flow of power.

In the related art, the efficiency of the water hammer effect is low, and it cannot form a sustained and stable power output.

### SUMMARY

In view of shortcomings of the related art, the disclosure provides a power system of water hammer effect. A loosened ring and a drainage collection ring on an inner wall of a cylinder body drain and release pressurized water inside the system, so that a piston quickly returns to its position without impact or compression, and then enters a next stamping stroke of the piston. Compared to the related art, the power system of water hammer effect of the disclosure shortens a time for piston impact compression and return, increases an efficiency of water hammer impact, and generates continuous and stable power output.

In order to achieve the above purpose, the disclosure adopts the following technical solutions.

A power system of water hammer effect includes a pressure cylinder connected to a pressure water pipe. A pressure branch pipe is disposed on the pressure water pipe, and a trigger valve is mounted on the pressure branch pipe. The pressure cylinder defines a hollow chamber, a piston is slidably mounted inside the hollow chamber, a piston rod is mounted on an end of the piston far away from the pressure water pipe, and the piston rod penetrates to an outside of the pressure cylinder and is slidably connected to the pressure cylinder. The hollow chamber defines a drainage cavity therein, the drainage cavity includes a loosened ring and a drainage collection ring, and the drainage collection ring defines a drainage port thereon. The compacted ring is disposed adjacent to the loosened ring. The compacted ring is located on an inner wall of a cylinder body of the pressure cylinder and close to the pressure water pipe, and the piston is configured to slide sealingly when in contact with the compacted ring.

In an embodiment of the disclosure, the pressure cylinder includes a cylinder cover and a cylinder body, and the cylinder cover is connected to the cylinder body through cylinder bolts.

In an embodiment of the disclosure, the hollow chamber includes a stroke cavity, the drainage cavity and a travel cavity sequentially connected in that order, and the loosened ring of the drainage cavity is disposed surrounding the piston. A diameter of the stroke cavity is smaller than a diameter of the piston, a diameter of the loosened ring is greater than the diameter of the piston, and the piston is reciprocally movable inside the travel cavity.

In an embodiment of the disclosure, the loosened ring and the drainage collection ring of the drainage cavity are connected to each other (i.e., in communication with each other), an end of the loosened ring adjacent to the stroke cavity is kept at a relative distance from an end of the piston, and a diameter of the drainage collection ring is greater than the diameter of the loosened ring.

In an embodiment of the disclosure, the drainage port is defined on a bottom of the drainage collection ring.

In an embodiment of the disclosure, an end of the travel cavity far away from the piston defines multiple blind holes, each of the multiple blind holes is mounted with a spring therein, and the spring is abutted against the piston.

In an embodiment of the disclosure, a free end of the piston rod is connected to a crankshaft through a connecting rod, and the crankshaft is connected to an electric generator.

In an embodiment of the disclosure, the pressure water pipe is sealingly and fixedly connected to the cylinder cover through a flange plate.

In an embodiment of the disclosure, an input end of the pressure water pipe is connected to a high pressure water inlet.

In an embodiment of the disclosure, the trigger valve is a quick-closing butterfly valve, a gate valve, or an electromagnetic shut-off valve.

Compared with the related art, the disclosure has the following beneficial effects.

1. In the disclosure, a pressurized water source (i.e., the high pressure water inlet) is connected to the input end of the pressure water pipe, so that the pressure water pipe and a front part of the hollow chamber are filled with pressurized water. The pressurized water flows out when the trigger valve is opened, then the trigger valve is suddenly closed, an instantaneous pressure wave is generated due to an inertia of water flow, and the instantaneous pressure wave will impact the piston and the wall of pipes like a hammer, thereby generating the water hammer effect. The generated water hammer effect impacts the piston, making the piston to move rapidly in a direction far away from the pressure water pipe. When the piston moves to a position of the loosened ring, the pressurized water inside the pressure water pipe and the hollow chamber is rapidly drained from the loosened ring, at this time, negative pressure is generated at the pressure water pipe and the front part of the hollow chamber, and with assistance of the spring, the piston and the piston rod move together in a direction facing towards the pressure water pipe. When pressure inside the pressure water pipe and the hollow chamber is greater than a bearing capacity of the piston, the piston moves in a direction facing away from the pressure water pipe, and the above actions are repeated over and over again, thereby generating reciprocating motion, and the piston rod generates a stable linear reciprocating motion along with the piston, which is conducive to generating a stable kinetic energy output. The disclosure can obtain the energy generated by the water hammer to the maximum extent through a function of a special structure of the loosened ring, so that the water hammer effect has conditions to become a continuous and stable power.

In the disclosure, when the trigger valve is opened and then suddenly closed, the water hammer phenomenon is caused due to the sudden interruption of the water flow. The water hammer impacts the piston, and the piston moves from a first position (the end of the piston is close to the cylinder cover) to a second position (the end of the piston is far away from the cylinder cover). According to a principle of mechanics, the greater the impact force, there will be a reaction force with the same force but opposite direction. The reaction force acts on the water body, and while instantly preventing the subsequent water pressure from advancing forward, it drives the piston to move back to the first position. At the same time, after completing a round of impact, the water hammer puts the device in a short state of no force. In this way, even if the piston is on the loosened ring of the second position, the contact between the piston and the pressure cylinder is relatively close, and a sticking effect of residual water between the piston and the cylinder body is sufficient to prevent outside air from entering the cylinder body. According to a principle of vacuum science, the piston will be tightly attached on this water body at this time and move back to the first position with the water body. In addition, the water in the container will drift in the opposite direction after it is impacted by an external force against the container wall on one side, which is the “reverberation” of water, and the reverberation of water helps to return the piston to the first position. Therefore, the piston moves back from the second position to the first position due to the combined effect of multiple factors, which enables the piston to successfully complete the return stroke. The piston moves back to the first position, and the subsequent pressure water impacts the piston again, causing the water hammer impact again, and this reciprocating process continues, and the device produces continuous and stable power output.

2. In the disclosure, the end of the loosened ring in the drainage cavity adjacent to the stroke cavity is kept at a relative distance from the end of the piston. The diameter of the drainage collection ring is greater than the diameter of the loosened ring, and the drainage port is defined on the bottom of the drainage collection ring. The loosened ring is disposed close to an outer wall of the piston, and the loosened ring is arranged along an axial direction of the piston. The drainage collection ring is connected to the loosened ring, and the diameter of the drainage collection ring is greater than the diameter of the loosened ring, and the drainage collection ring can quickly collect water leaked from the loosened ring.

In the disclosure, the loosened ring is set to be narrow and long, which is conducive to the stable and long-term water drainage at the loosened ring during the compression of the piston, and increases the stroke of the piston on the loosened ring. During the water drainage of the loosened ring, the water film is always attached between the piston and the cylinder body, preventing the external air from entering the inside of the pressure water pipe, which is conducive to the reciprocating motion of the piston, and further promotes the device of the disclosure to produce stable and continuous power output. The loosened ring and the drainage collection ring on the inner wall of the cylinder body drain and release the pressurized water inside the system, so that the piston quickly returns to its position without impact or compression, and then enters a next stamping stroke of the piston. Compared to the related art, the power system of water hammer effect of the disclosure shortens a time for piston impact compression and return, increases the efficiency of water hammer impact, and generates continuous and stable power output.

### BRIEF DESCRIPTION OF DRAWINGS

FIG. 1 illustrates a schematic perspective view of an entire structure of a power system of water hammer effect according to the disclosure.

FIG. 2 illustrates a schematic cut-away perspective structural view of a pressure cylinder of the power system of water hammer effect according to the disclosure.

FIG. 3 illustrates a schematic cut-away exploded structural view of the pressure cylinder of the power system of water hammer effect according to the disclosure.

FIG. 4 illustrates a schematic cut-away perspective structural view showing bind holes inside a cylinder body of the power system of water hammer effect according to the disclosure.

FIG. 5 illustrates a schematic diagram of a connection relationship between a piston rod and an electric generator according to the disclosure.

### DESCRIPTION OF REFERENCE SIGNS:

10-cylinder body; 11-cylinder cover; 12-pressure cylinder; 13-drainage port; 14-high pressure water inlet; 15-pressure branch pipe; 16-trigger valve; 17-pressure water pipe; 18-flange plate; 19-hollow chamber; 20-stroke cavity; 21-loosened ring; 22-drainage collection ring; 23-travel cavity; 24-spring; 25-piston; 26-piston rod; 27-cylinder cover hole; 28-cylinder body hole; 29-cylinder bolt; 30-bind hole; 31-compacted ring; 32-connecting rod; 33-crankshaft; 34-electric generator.

### DETAILED DESCRIPTION OF EMBODIMENTS

Technical solutions in embodiments of the disclosure will be clearly and completely described below in combination with the embodiments of the disclosure. Apparently, the described embodiments are merely some of the embodiments of the disclosure, rather than all of the embodiments.

Contents not described in detail in this specification belong to the related art known to those skilled in the art. In the description of the disclosure, it should be understood that orientation or position relationship indicated by terms “center”, “upper”, “lower”, “front”, “back”, “left”, “right”, “vertical”, “horizontal”, “top”, “bottom”, “inner”, “outer”, “clockwise”, “counterclockwise” and the like is based on an orientation or position relationship shown in drawings, which is merely for convenience of describing the disclosure and simplifying the description, and does not indicate or imply that a device or component referred to must have a specific orientation, be constructed and operated in a specific orientation, and therefore cannot be understood as a limitation of the disclosure. In addition, terms “first”, “second”, “third” and the like are merely used to distinguish the description, and cannot be understood as indicating or implying relative importance.

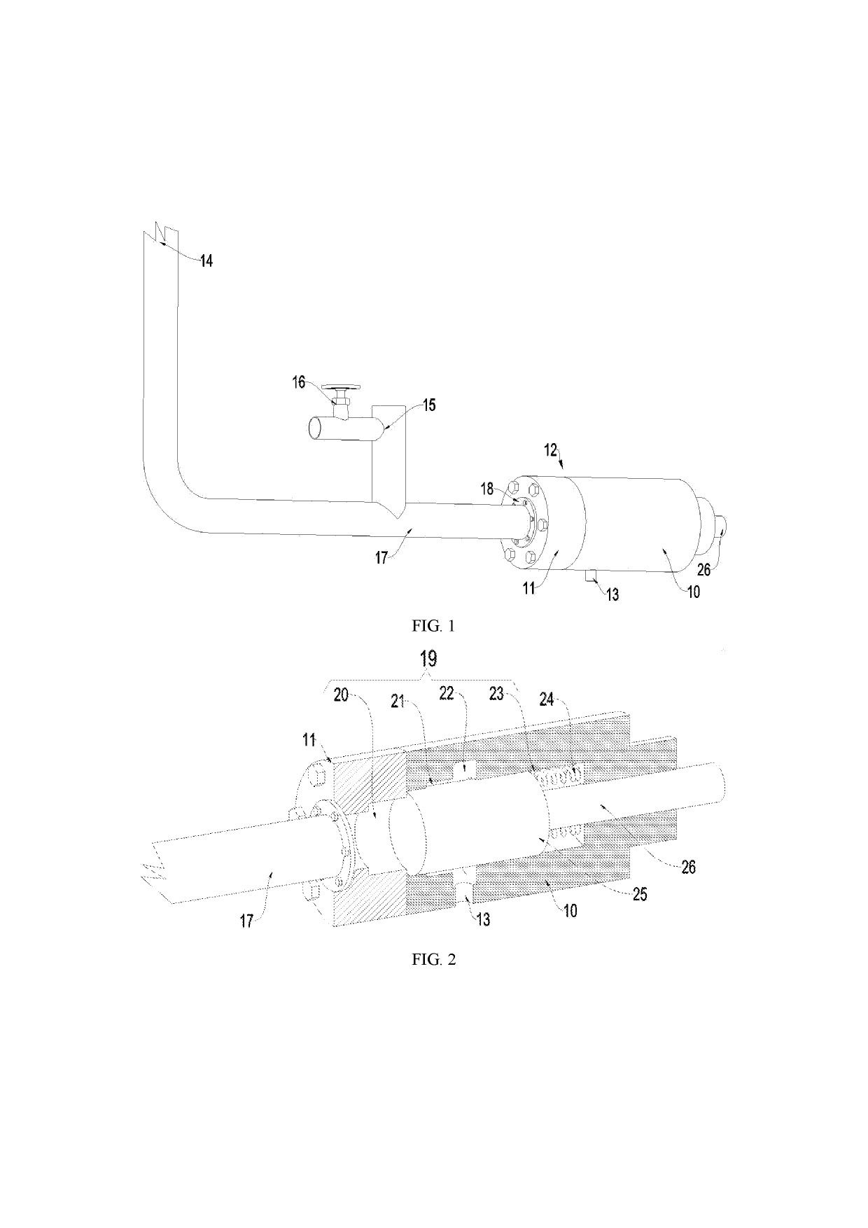

As shown in FIG. 1 to FIG. 4, a power system of water hammer effect includes a pressure cylinder 12 connected to a pressure water pipe 17. A pressure branch pipe 15 is disposed on the pressure water pipe 17, and a trigger valve 16 is mounted on the pressure branch pipe 15. The pressure cylinder 12 defines a hollow chamber 19, a piston 25 is slidably mounted inside the hollow chamber 19, a piston rod 26 is mounted on an end of the piston 25 far away from the pressure water pipe 17, and the piston rod 26 penetrates to an outside of the pressure cylinder 12 and is slidably connected to the pressure cylinder 12. The pressure water pipe 17 is configured to provide pressurized water to the hollow chamber 19. A loosened ring 21 is disposed in the hollow chamber 19, and a drainage collection ring 22 connected to the loosened ring 21 defines a drainage port 13 thereon. A compacted ring 31 is disposed adjacent to the loosened ring 21. The compacted ring 31 is located on an inner wall of a cylinder body 10 of the pressure cylinder 12 and located on a side of the loosened ring close to the pressure water pipe 17, and the piston 25 is configured to slide sealingly when in contact with the compacted ring 31.

Specifically, a pressurized water source (i.e., a high pressure water inlet) 14 is connected to an input end of the pressure water pipe 17, so that the pressure water pipe 17 and a front part of the hollow chamber 19 are filled with pressurized water when the water source is connected. The pressurized water flows out when the trigger valve 16 is opened, then the trigger valve 16 is suddenly closed, an instantaneous pressure wave is generated due to an inertia of water flow, and the instantaneous pressure wave will impact the piston 25 and the wall of pipes like a hammer, thereby generating the water hammer effect, that is, the trigger valve 16 is configured to control inflow and sudden interruption of the pressurized water to the hollow chamber 19, to thereby generate the water hammer effect. The generated water hammer effect impacts the piston 25, making the piston 25 to move rapidly in a direction far away from the pressure water pipe 17. When the piston 25 moves to a position of the loosened ring 21, the pressurized water inside the pressure water pipe 17 and the hollow chamber 19 is rapidly drained from the loosened ring 21, at this time, negative pressure is generated at the pressure water pipe 17 and the front part of the hollow chamber 19, and the piston 25 and the piston rod 26 move together in a direction facing towards the pressure water pipe 17. When pressure inside the pressure water pipe 17 and the hollow chamber 19 is greater than a bearing capacity of the piston 25, the piston 25 moves in a direction facing away from the pressure water pipe 17, and the above actions are repeated over and over again, thereby generating reciprocating motion. The disclosure can continuously and effectively impact the piston 25, and the piston rod 26 can convert the reciprocating linear motion into circular motion, thereby further driving the generator to generate electricity.

A journey of the inventor to further develop natural hydropower has spanned over a decade. Since first observing a faulty faucet in early 2014, the inventor began contemplating and conceptualizing a new method for extracting hydropower. In 2017, the inventor introduced the “Vibration-based Hydropower Generation Technology”, and in 2019, the inventor developed a “Hydropower Conversion Device”. These achievements document progression of the inventor from initial attempts to gradual growth and maturation, a path fraught with challenges. After more than ten years of relentless exploration, the inventor has now identified the development of water hammer power as the most promising direction. The inventor hope that, much like the invention of the steam engine inspired by the sight of boiling water, this endeavor will provide modernized equipment for the development of natural hydropower.

In order to transform the energy generated by the water hammer effect into usable power, it is imperative to address a critical issue of achieving continuous and effective impacts. This involves two core elements: continuity and effectiveness. Continuity is the foundation, without uninterrupted impacts, a stable power source cannot be established. Effectiveness is the key, only through effective impacts can the true value of this energy as a power source be realized. The water hammer phenomenon is caused by the faulty faucet, which drains only 1.5 g of water per vibration, and is sufficient to create a commotion throughout the entire building. Such a minuscule amount of water drainage can impact a faucet component weighing 38 g. How is this highly efficient vibration effect achieved? After extensive observation and deep contemplation, the inventor has understood a solution of a “leakage drainage technology”. This technological solution successfully addresses the challenge of achieving continuous and effective impacts. Often, “seeing” alone does not yield much value; it is “insight” that is the wellspring of creativity.

A manifestation of water hammer power is an intermittent impact process, where power is generated through successive waves of impact. After an impact occurs, the water hammer needs a release mechanism; without it, the next impact cannot take place. How does the disclosure solve the release problem of water hammer power? In order to clarify this, a comparison with a gas piston is as follows.

The gas piston generates power through combustion, while the water hammer phenomenon generates energy through impact. Although not identical, both combustion and impact are instantaneous bursts. Such instantaneous bursts must be released after generating energy to create conditions for the next burst. However, there is a significant difference between the water hammer effect and the gas piston that the gas piston relies on fuel, and only by exhausting the waste gases can it achieve a full combustion cycle, making the expulsion of waste gases as the release mechanism for the gas piston. In contrast, the water hammer effect faces a paradox, when all the water is exhausted, where does the impact come from? On the one hand, without release, there is no next impact; on the other hand, when all the water is exhausted, even the current impact opportunity is lost. This seems to be a dilemma. A key to solving this problem lies in the adoption of a leakage-based drainage method. Why choose leakage? Because the water hammer power is generated through impact, and when too much water is drained, the power obtained will be significantly reduced. Therefore, a core of mastering water hammer power technology is to both maximize the energy generated by the water hammer and allow for a certain degree of release. Through leakage-based drainage technology, the release problem can be solved without weakening the impact force of the water hammer.

The disclosure can achieve both continuous and effective impact through the leakage type drainage technology, and the key to this is a double-layer design inside the pressure cylinder 12.

The inside of the pressure cylinder 12 includes the compacted ring 31 and the loosened ring 21. The compacted ring 31 is disposed on a front position of a pressure pipe (the compacted ring 31 is a portion on the inner wall of the cylinder body 10 close to the pressure water pipe 17), the compacted ring 31 is short, and is used to effectively convert the energy generated by water hammer into the power to drive the piston 25. The loosened ring 21 is much longer than the compacted ring 31, which extends from a rear end of the compacted ring 31 to the second position where the piston 25 moves, and an annular structure of the loosened ring 21 is slightly larger than that of the compacted ring 31. In an embodiment, a compacted ring 31, a loosened ring 21 and a drainage collection ring 22 are sequentially disposed in the pressure cylinder 12 in that order and connected with one another.

The loosened ring 21 is a core of the “leakage drainage technology”, and its ingenuity lies in its unique structural design, which directly determines an energy conversion efficiency of the water hammer. Although the energy generated by the water hammer can be relatively efficiently converted into the driving force for the piston 25 under an action of the compacted ring 31, when the design of the loosened ring 21 is not precise enough, the actual power obtained will be greatly reduced and may even affect the energy generated by the next water hammer effect. Therefore, the design of the loosened ring 21 plays a crucial role in the functional performance of the entire device. It is necessary to precisely control the tightness between the piston 25 and the pressure pipes. When it is too tight, the leakage effect cannot be achieved. When it is too loose, leakage will occur when it should not have leaked. Therefore, it must be ensured that the device does not leak under normal water pressure, and only controlled drainage occurs during the water hammer impact. In this way, the energy generated by the water hammer can not only be effectively converted into power but also reasonably released.

The looseness of the loosened ring 21 is relative, compared to the compactness of the compacted ring 31. An inspiration for this design comes from the water hammer phenomenon caused by the faulty faucet (which is still preserved). Under normal circumstances, the faulty faucet does not leak water. the faulty faucet only leaks a very small amount of water when the water supply is suddenly turned off after being opened due to the impact of the water hammer. This design neither hinders the acquisition of energy generated by the water hammer nor prevents the release of the water hammer energy to some extent, thus creating conditions for the next impact.

Regarding a drainage mechanism during operation of the piston 25, when the piston 25 is impacted by the water hammer effect, the piston 25 begins to move from the first position. The piston 25 initially resides within the compacted ring 31 of the pressure cylinder 12, where the high sealing efficiency prevents any leakage despite the pressure exerted by the water hammer. However, the compacted ring 31 is relatively short, and the piston 25 quickly moves into the loosened ring 21. It should be noted that the looseness of the loosened ring 21 is relative, compared to the compactness of the compacted ring 31. Under normal water pressure, the loosened ring 21 does not leak. The loosened ring 21 is only under the intense impact of the water hammer energy that it is squeezed to expel a small amount of water. Since the amount of water expelled is minimal, this allows us to maximize the capture of energy generated by the water hammer, which is the key to the efficient utilization of water hammer energy of the disclosure. More importantly, this small amount of water expelled is sufficient to release the water hammer energy, thereby placing the water body around the piston 25 in a relatively relaxed state and creating favorable conditions for the next effective impact of the water hammer.

In an embodiment, the pressure cylinder 12 includes a cylinder cover 11 and a cylinder body 10, and the cylinder cover 11 is connected to the cylinder body 10 through cylinder bolts 29. The compacted ring 31, the loosened ring 21 and the drainage collection ring 22 all are located on the cylinder body 10.

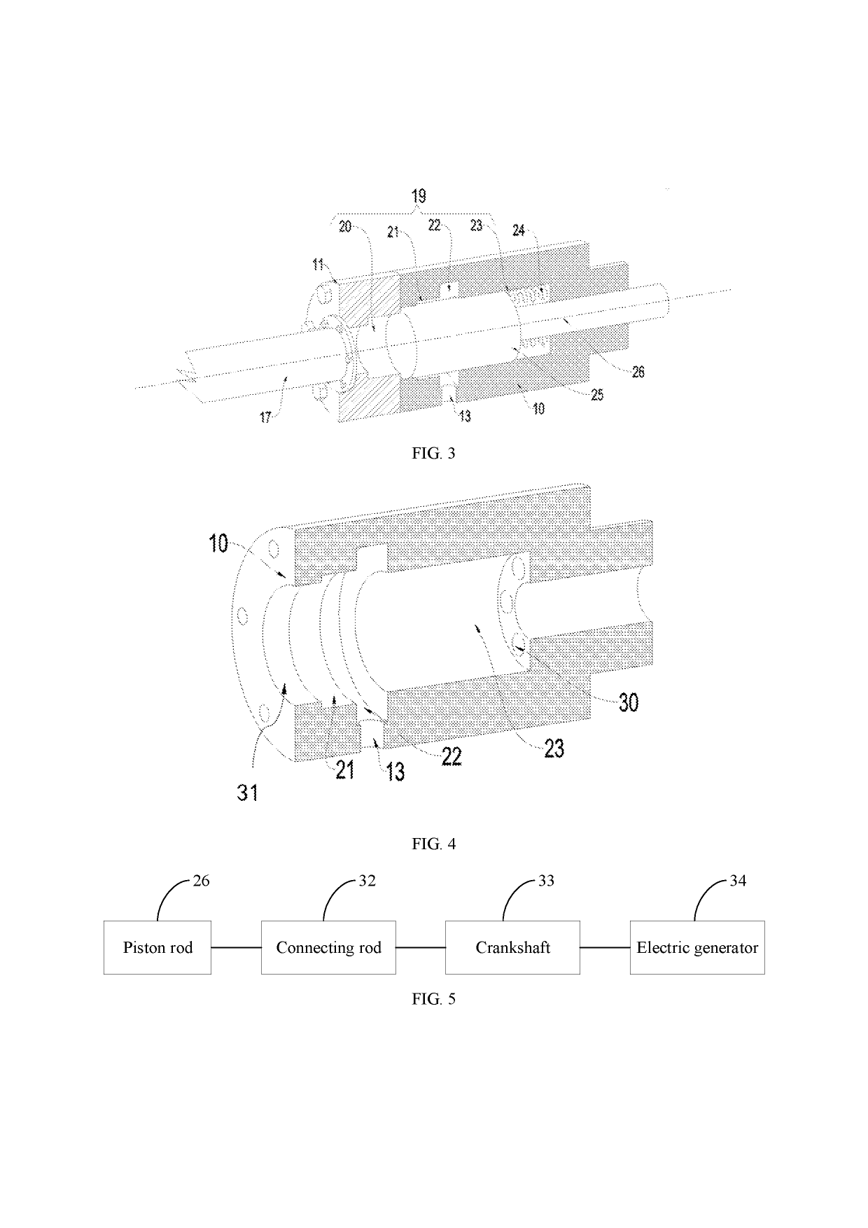

As shown in FIG. 2 and FIG. 3, an inner diameter of the cylinder cover 11 is smaller than the diameter of the piston 25, and a front chamber (i.e., a stroke cavity20) of the hollow chamber 19 is located inside the cylinder cover 11. Each cylinder bolt 29 penetrates through a cylinder cover hole 27 to connect with a cylinder body hole 28, which is conductive to detachment and installation of the pressure cylinder 12, and exchange of assemblies inside the pressure cylinder 12.

In an embodiment, the hollow chamber 19 includes a stroke cavity 20, the drainage cavity and a travel cavity 23 sequentially connected in that order, the loosened ring 21 of the drainage cavity is disposed surrounding the piston 25, and the loosened ring 21 is configured to release the pressurized water inside the drainage cavity. The compacted ring 31 is disposed on a position of the inner wall of the hollow chamber 19 adjacent to the loosened ring 21, a diameter of the stroke cavity 20 is smaller than a diameter of the piston 25, and the piston 25 is disposed to be slidably in contact with the compacted ring 31. A diameter of the loosened ring 21 is greater than the diameter of the piston 25, and the piston 25 is reciprocally movable inside the travel cavity 23. In an embodiment, the compacted ring 31 is located between the stroke cavity 20 and the drainage cavity.

As shown in FIG. 2 and FIG. 3, the diameter of the loosened ring 21 is greater than the diameter of the piston 25. An inner wall of the cylinder body 10 located on two sides of the loosened ring 21 and the drainage collection ring 22 is closely attached to the piston 25 and slidably disposed. When the end of the piston 25 moves to the position of the loosened ring 21, the pressurized water is drained out from the drainage port 13 connected to the loosened ring 21. When the end of the piston 25 leaves the position of the loosened ring 21, that is, when the end of the piston 25 is closely attached with the inner wall of the cylinder body 10, the piston 25 prevents water in the pressure water pipe 17 from flowing out, thereby keeping a sealing state.

The cylinder body 10 includes the compacted ring 31 (the compacted ring 31 is a portion on the inner wall of the cylinder body 10 located between the loosened ring 21 and the cylinder cover 11). The compacted ring 31 is closely attached to the piston 25, and the compacted ring 31 is short, and is used to effectively convert the energy generated by water hammer into the power to drive the piston 25. An axial length of the loosened ring 21 is greater than three times the axial length of the compacted ring 31, which extends from the rear end of the compacted ring 31 to the second position where the piston 25 moves, and the annular structure of the loosened ring 21 is larger than the diameter of the compacted ring 31. The axial direction of the loosened ring 21 and the compacted ring 31 along a direction as shown in FIG. 3.

In an embodiment, the loosened ring 21 and the drainage collection ring 22 of the drainage cavity are connected to each other, an end of the loosened ring 21 adjacent to the stroke cavity 20 is kept at a relative distance from an end of the piston 25, and the diameter of the drainage collection ring 22 is greater than the diameter of the loosened ring 21. In an embodiment, the drainage port 13 is defined on a bottom of the drainage collection ring 22.

As shown in FIG. 2, FIG. 3 and FIG. 4, the loosened ring 21 is disposed tightly against the outer wall of piston 25, and the loosened ring 21 is disposed along an axial direction of the piston 25. The drainage collection ring 22 and the loosened ring 21 are connected to each other, and the diameter of the drainage collection ring 22 is greater than the diameter of the loosened ring 21, so that the drainage collection ring 22 can rapidly collect water drained from the loosened ring 21. In the disclosure, the loosened ring 21 is set to be narrow and long, which is conducive to the stable and long-term water discharge at the loosened ring 21 during the compression of the piston 25, and increases the stroke of the piston 25 on the loosened ring 21. During the water discharge of the loosened ring 21, the water film is always attached between the piston 25 and the cylinder body 10, preventing the external air from entering the inside of the pressure water pipe 17, which is conducive to the reciprocating motion of the piston 25.

In an embodiment, an end of the travel cavity 23 far away from the piston 25 defines multiple blind holes 30, each of the multiple blind holes 30 is mounted with a spring 24 therein, and the spring 24 is abutted against the piston 25.

As shown in FIG. 4, the travel cavity 23 defines the multiple blind holes 30 therein, and each of the multiple blind holes 30 is mounted with the spring 24 therein. The blind hole 30 serves as a limit for the spring 24, preventing radial displacement or excessive bending of the spring 24, which affects the reciprocating motion of the piston 25.

In an embodiment, a free end of the piston rod 26 is connected to a crankshaft 33 through a connecting rod 32, and the crankshaft 33 is connected to an electric generator 34.

The piston 25 and the piston rod 26 reciprocate together, and the motion of the piston rod 26 can be converted into circular motion through the connecting rod 32 and the crankshaft 33, and the continuous circular motion is then converted into kinetic energy through the electric generator 34.

In an embodiment, the pressure water pipe 17 is sealingly and fixedly connected to the cylinder cover 11 through a flange plate 18.

As shown in FIG. 1 and FIG. 2, a sealing pad (not shown in drawings) is disposed on a connection between the flange plate 18 and the cylinder cover 11, which is conductive to the smooth passage of the pressurized water.

In an embodiment, an input end of the pressure water pipe 17 is connected to a high pressure water inlet 14. In an embodiment, an end of the pressure water pipe 17 is sealingly and fixedly connected to the cylinder cover 11 through the flange plate 18, and another end of the pressure water pipe 17 is connected to the high pressure water inlet 14.

As shown in FIG. 1, the high pressure water inlet 14 may be a pressurized water source or a water source falling from a height, which generates pressure inside the pressure pipe and is conducive to generating the water hammer effect.

In an embodiment, the trigger valve 16 is a quick-closing butterfly valve, a gate valve, or an electromagnetic shut-off valve.

As shown in FIG. 1, in the water hammer effect, stopping the flowing pressurized water suddenly is an important condition for starting the water hammer effect. The trigger valve 16 adopts the quick-closing butterfly valve, the gate valve, or the electromagnetic shut-off valve. In an embodiment, the trigger valve 16 is a gate valve.

The trigger valve 16 is opened and suddenly closed, at this time, the water hammer phenomenon is caused due to the sudden interruption of the water flow. The water hammer impacts the piston 25, and the piston 25 moves from a first position (the end of the piston 25 is close to the cylinder cover 11) to a second position (the end of the piston 25 is far away from the cylinder cover 11). According to a principle of mechanics, the greater the impact force, there will be a reaction force with the same force but opposite direction. The reaction force acts on the water body, and while instantly preventing the subsequent water pressure from advancing forward, it drives the piston 25 to move back to the first position. At the same time, after completing a round of impact, the water hammer puts the device in a short state of no force. In this way, even if the piston 25 is on the loosened ring 21 of the second position, the contact between the piston 25 and the pressure cylinder 12 is relatively close, and a sticking effect of residual water between the piston 25 and the cylinder body 10 is sufficient to prevent outside air from entering the cylinder body 10. According to a principle of vacuum science, the piston 25 will be tightly attached on this water body at this time and move back to the first position with the water body.

Water still has an important characteristic that is often overlooked by people, that is, the water in the container will drift in the opposite direction after it is impacted by an external force against the container wall on one side, which is the reverberation of water, and the reverberation of water is very important, which helps to return the piston 25 to the first position. Therefore, the piston 25 moves back from the second position to the first position due to the combined effect of multiple factors, which enables the piston 25 to successfully complete the return stroke.

The piston 25 moves back to the first position, and the water phenomenon disappears. The subsequent high pressure water impacts the piston 25 again, causing water hammer to occur again. This cycle continues, and the device can operate normally.

The energy generated by the water hammer effect is extremely powerful, reaching up to two hundred times the original water pressure. In the disclosure, the water hammer effect is made to be continuous and effective in impact, ensuring efficient energy conversion. Specifically, the water inside the pressure pipe of the disclosure is not used for transportation or other purposes, but is specifically used to generate the water hammer effect to drive the piston. From the perspective of energy conversion, this design significantly improves the energy utilization rate, making the reciprocating motion of the piston more efficient.

The disclosure illustrates a technical concept of the disclosure through the above embodiments, but the disclosure is not limited to the above embodiments, that is, it does not mean that the disclosure must rely on the above embodiments to be implemented. Those skilled in the art should understand that relevant improvements to the disclosure fall within a protection scope and a disclosure scope of the disclosure.

What is claimed is:

1. A power system of water hammer effect, comprising a pressure cylinder (12) connected to a pressure water pipe (17), a pressure branch pipe (15) disposed on the pressure water pipe (17), and a trigger valve (16) mounted on the pressure branch pipe (15);
wherein the pressure cylinder (12) defines a hollow chamber (19), and a compacted ring (31) and a loosened ring (21) are adjacently arranged inside the pressure cylinder (12); a piston (25) is slidably mounted inside the hollow chamber (19), a piston rod (26) is mounted on an end of the piston (25) far away from the pressure water pipe (17), and the piston rod (26) penetrates to an outside of the pressure cylinder (12) and is slidably connected to the pressure cylinder (12); the hollow chamber (19) defines a drainage cavity therein, the drainage cavity comprises the loosened ring (21) and a drainage collection ring (22), and the drainage collection ring (22) defines a drainage port (13) thereon; and the compacted ring (31) is disposed adjacent to the loosened ring (21).

2. The power system of water hammer effect as claimed in claim 1, wherein the hollow chamber (19) comprises a stroke cavity (20), the drainage cavity, and atravel cavity (23) sequentially connected in that order; the loosened ring (21) of the drainage cavity is disposed surrounding the piston(25), and the loosened ring(21) is configured to release pressurized water inside the drainage cavity; the compacted ring (31)is disposed on an inner wall of the hollow chamber (19) adjacent to the loosened ring (21), the compacted ring (31)is located on an inner wall of a cylinder body (10)of the pressure cylinder (12) and close to the pressure waterpipe (17), and the piston (25)is configured to slide sealingly when in contact with the compacted ring(31); and a diameter of the stroke cavity (20) is smaller thana diameter of the piston(25), and the piston(25)is disposed to be slidably in contact with the compacted ring (31), a diameter of the loosened ring (21) is greater than a diameter of the compacted ring (31), and the piston (25) is reciprocally movable inside the travel cavity (23).

3. The power system of water hammer effect as claimed in claim 2, wherein the loosened ring (21) and the drainage collection ring (22) of the drainage cavity are in communication with each other, an end of the loosened ring (21) adjacent to the stroke cavity (20) is kept at a relative distance from an end of the piston (25), and a diameter of the drainage collection ring (22) is greater than the diameter of the loosened ring (21).

4. The power system of water hammer effect as claimed in claim 1, wherein the pressure cylinder (12) comprises a cylinder cover (11) and a cylinder body (10), and the cylinder cover (11) is connected to the cylinder body (10) through cylinder bolts (29).

5. The power system of water hammer effect as claimed in claim 4, wherein the drainage port (13) is defined on a bottom of the drainage collection ring (22).

6. The power system of water hammer effect as claimed in claim 3, wherein an end of the travel cavity (23) far away from the piston (25) defines a plurality of blind holes (30), each of the plurality of blind holes (30) is mounted with a spring (24) therein, and the spring (24) abuts against the piston (25).

7. The power system of water hammer effect as claimed in claim 1, wherein a free end of the piston rod (26) is connected to a crankshaft (33) through a connecting rod (32), and the crankshaft (33) is connected to an electric generator (34).

8. The power system of water hammer effect as claimed in claim 4, wherein the pressure water pipe (17) is sealingly and fixedly connected to the cylinder cover (11) through a flange plate (18).

9. The power system of water hammer effect as claimed in claim 1, wherein an input end of the pressure water pipe (17) is connected to a water inlet (14).

10. The power system of water hammer effect as claimed in claim 1, wherein the trigger valve (16) is a quick-closing butterfly valve, a gate valve, or an electromagnetic shut-off valve.

11. A power system of water hammer effect, comprising:
a pressure cylinder (12);
a pressure water pipe (17), connected to the pressure cylinder (12); and
a piston (25), slidably mounted inside the pressure cylinder (12), wherein a piston rod (26) is mounted on an end of the piston (25) far away from the pressure water pipe (17), and the piston rod (26) penetrates to an outside of the pressure cylinder (12); and
wherein a compacted ring (31), a loosened ring (21) and a drainage collection ring (22) are sequentially disposed in the pressure cylinder (12) in that order and connected with one another, the compacted ring (31) is disposed on a side of the loosened ring (21) close to the pressure water pipe (17), and a bottom of the drainage collection ring (22) defines a drainage port (13); and a diameter of the compacted ring (31) is smaller than a diameter of the loosened ring (21), and a diameter of the drainage collection ring (22) is greater than the diameter of the loosened ring (21).

12. The power system of water hammer effect as claimed in claim 11, wherein an axial length of the loosened ring (21) is greater than three times of an axial length of the compacted ring (31).

13. The power system of water hammer effect as claimed in claim 11, wherein a pressure branch pipe (15) is disposed on the pressure water pipe (17), and a trigger valve (16) is mounted on the pressure branch pipe (15).

14. The power system of water hammer effect as claimed in claim 11, wherein the pressure cylinder (12) comprises a cylinder cover (11) and a cylinder body (10), and the cylinder cover (11) is connected to the cylinder body (10) through cylinder bolts (29); and the compacted ring (31), the loosened ring (21) and the drainage collection ring (22) all are located on the cylinder body (10).

15. The power system of water hammer effect as claimed in claim 11, wherein the pressure cylinder (12) defines a hollow chamber (19), and the hollow chamber (19) comprises a stroke cavity (20), a drainage cavity, and a travel cavity (23) sequentially connected in that order, the compacted ring (31) is located between the stroke cavity (20) and the drainage cavity, the loosened ring (21) and the drainage collection ring (22) are disposed in the drainage cavity, and the piston (25) is reciprocally movable inside the travel cavity (23).

16. The power system of water hammer effect as claimed in claim 15, wherein an end of the travel cavity (23) far away from the piston (25) defines a plurality of blind holes (30), each of the plurality of blind holes (30) is mounted with a spring (24) therein, and the spring (24) abuts against the piston (25).

17. The power system of water hammer effect as claimed in claim 14, wherein an end of the pressure water pipe (17) is sealingly and fixedly connected to the cylinder cover (11) through a flange plate (18), and another end of the pressure water pipe (17) is connected to a water inlet (14).

18. A power system of water hammer effect, comprising:
a pressure cylinder (12), defining a hollow chamber (19) therein;
a pressure water pipe (17), connected to the pressure cylinder (12) and configured to provide pressurized water to the hollow chamber (19);
a pressure branch pipe (15), disposed on the pressure water pipe (17);
a trigger valve (16), mounted on the pressure branch pipe (15) and configured to control inflow and sudden interruption of the pressurized water to the hollow chamber (19), to thereby generate the water hammer effect;
a piston (25), slidably mounted inside the hollow chamber (19), wherein a piston rod (26) is mounted on an end of the piston (25) far away from the pressure water pipe (17), and the piston rod (26) penetrates to an outside of the pressure cylinder (12);a drainage cavity, defined in the hollow chamber (19), and comprising a loosened ring (21) and a drainage collection ring (22) connected with each other, wherein the drainage collection ring (22) defines a drainage port (13) thereon; and
a compacted ring (31), formed on an inner wall of the hollow chamber (19), wherein the compacted ring (31) is located on a side of the drainage cavity close to the pressure water pipe (17), wherein the piston (25) is configured to slide sealingly when in contact with the compacted ring (31); and
wherein a diameter of the compacted ring (31) is smaller than a diameter of the loosened ring (21), a diameter of the drainage collection ring (22) is greater than the diameter of the loosened ring (21), and the drainage collection ring (22) is configured to collect the pressurized water drained from the loosened ring (21) and discharge the pressurized water through the drainage port (13).

19. The power system of water hammer effect as claimed in claim 18, wherein the hollow chamber (19) comprises a stroke cavity (20), the drainage cavity, and a travel cavity (23) sequentially connected in that order, a diameter of the stroke cavity (20) is smaller than a diameter of the piston (25), and the piston (25) is reciprocally movable inside the travel cavity (23).

20. The power system of water hammer effect as claimed in claim 19, wherein an end of the travel cavity (23) far away from the piston (25) defines a plurality of blind holes (30), each of the plurality of blind holes (30) is mounted with a spring (24) therein, and the spring (24) abuts against the piston (25).
